(19) United States
(12) Patent Application Publication
(10) Pub. No.: US 2011/0236565 A1
(43) Pub. Date: Sep. 29, 2011

(54) ELECTROLESS PALLADIUM PLATING SOLUTION AND METHOD OF USE

(75) Inventors: Anthony M Piano, Lodi, NJ (US); James Trainor, Bethlehem, PA (US)

(73) Assignee: OMG AMERICAS, INC., Westlake, OH (US)

(21) Appl. No.: 13/130,637

(22) PCT Filed: Dec. 4, 2009
(86) PCT No.: PCT/US09/66767

§ 371 Date: May 23, 2011

Related U.S. Application Data
(60) Provisional application No. 61/120,127, filed on Dec. 5, 2008.

(51) Int. Cl. B05D 5/12; C09D 5/00

(52) U.S. Cl. 427/99.2; 106/1.05

(57) ABSTRACT

An electroless palladium plating solution includes a polar solvent, at least one palladium salt, at least one non-nitrogenated complexing agent, an alkaline adjusting agent that adjusts the plating solution to a pH of at least 8.0, and a reducing agent. The plating solution, which is used for forming a layer of palladium on a surface of a substrate, yields a substantially pure palladium deposit on the substrate. Precipitation of reduced palladium in the plating solution is substantially prevented.

### CROSS-REFERENCE TO RELATED APPLICATION

This international patent application claims priority to and the benefit of U.S. Provisional Application No. 61/120,127 filed Dec. 5, 2008, which is incorporated herein by reference.

### TECHNICAL FIELD

The invention relates to an electroless plating solution and a method of use thereof. More particularly, the invention relates to an electroless palladium plating solution and a method of use thereof.

### BACKGROUND OF THE INVENTION

Base metals can be protected against the attack of aggressive gases or liquids by means of corrosion resistant metal films, the type of which is determined essentially by the intended use of the article. For example in a welding wire, iron/steel is protected against rusting by thin copper film, deposited thereon. In the electronics industry, gold is commonly used for coating surfaces to be bonded or soldered or surfaces for electrical contact. Silver is generally not used for corrosion protection due to its tendency to migrate. Nickel films may also be used for corrosion protection of, for example, copper and copper alloys.

Palladium films act as excellent barrier layers for preventing migration of other metals in a substrate, such as an electrical contact, to the surface of the contact where oxidation of the other metal could take place. First the surfaces are superficially activated. Then the article having the surfaces to be coated is dipped into an acidic palladium solution, so that extremely fine palladium particles are formed, and on which the deposition of nickel starts. The palladium coating is not sealed but is very finely distributed. The palladium coated surfaces may have a gray appearance. It is the subsequent nickel coating that seals the surface completely.

There are essentially three methods of producing a layer of palladium on a surface. These methods are the electroplating or electrodeposition method, the vapor deposition method, and the electroless plating method. The electrodeposition method requires elaborate, expensive equipment to ensure deposition at the correct rate and the proper potential. An additional shortcoming of the electrodeposition method is that electric contact must be made to the surface being plated. For highly complex circuit patterns and in particular in integrated circuits where feature density is high, such electric contact is time consuming and difficult to accomplish. In addition, the surface being plated must be electrically conducting and connected to an external source of voltage and current. Vapor deposition also has some inherent disadvantages. In many applications, elaborate high vacuum equipment is required and considerable palladium metal is wasted in the evaporation procedure. There is no convenient way to require the evaporated palladium to adhere only to selected areas on the surface being plated. In other words, pattern delineation with palladium is not easily carried out using the vapor deposition procedure.

Particularly desirable is an electroless plating procedure for palladium in which the palladium plates out on particular surfaces, generally catalytic or sensitized surfaces. Further, it is desirable that such a procedure be carried out using a reasonably stable plating solution. Also, it is desirable that the electroless palladium plating procedure yields plating thicknesses of practical interest particularly where the palladium is used as conducting elements in electrical circuits such as integrated circuits.

Notwithstanding the state of the art as described herein, there is a need for further improvements in preparing and using electroless palladium plating solutions which includes providing a more stable palladium plating bath in which the precipitation of reduced palladium is substantially prevented and yields a substantially pure palladium deposit onto the surface of an article.

### SUMMARY OF THE INVENTION

In general, one aspect of the invention is to provide an electroless plating solution. The electroless plating solution may include a polar solvent; at least one palladium salt; at least one non-nitrogenated complexing agent; an alkaline adjusting agent, wherein the adjusting agent adjusts the plating solution to a pH of at least 8.0; and a reducing agent.

Another aspect of the invention is to provide a method for forming a layer of palladium on a surface of an article. The method may include the steps of providing an article having a metal surface, providing a bath comprising a palladium salt at a pH of greater than 8.0, substantially preventing precipitation of the palladium from the bath by providing at least one non-nitrogenated complexing agent selected from the group consisting of sodium citrate, ammonium citrate, sodium malate, sodium phenol sulfonate, sodium tartrate, and potassium sodium tartrate, reducing the palladium from the bath by providing a reducing agent, and contacting the metal surface to the bath such that a layer of palladium is formed on at least a portion of the metal surface.

A further aspect of the invention is to provide an electroless plating solution. The electroless plating solution may include water, palladium sulfate, ammonium citrate, ammonium hydroxide, wherein the ammonium hydroxide adjusts the plating solution to a pH of at least 8.0, sodium phenol sulfonate, and sodium formate.

In yet another aspect of the invention, a method of forming a layer of palladium on a surface of an article is provided. The method includes the steps of providing an article having a metal surface, wherein the article is selected from the group consisting of a circuit board, a microelectrode and an electronic component, providing a working bath comprising a palladium salt at a pH of greater than 8.0, preventing precipitation of the palladium from the bath by providing at least one non-nitrogenated complexing agent selected from the group consisting of sodium citrate, ammonium citrate, sodium malate, sodium phenol sulfonate, sodium tartrate, and potassium sodium tartrate, reducing the palladium from the bath by providing a reducing agent; and contacting the metal surface to the bath such that a layer of palladium is formed on at least a portion of the metal surface.

In still yet another embodiment of the invention, an electroless plating solution is provided. The electroless plating solution includes water, palladium sulfate, ammonium citrate, ammonium hydroxide, wherein the ammonium hydroxide adjusts the plating solution to a pH of at least 8.0, sodium phenol sulfonate, and sodium formate.

### DETAILED DESCRIPTION OF THE DRAWINGS

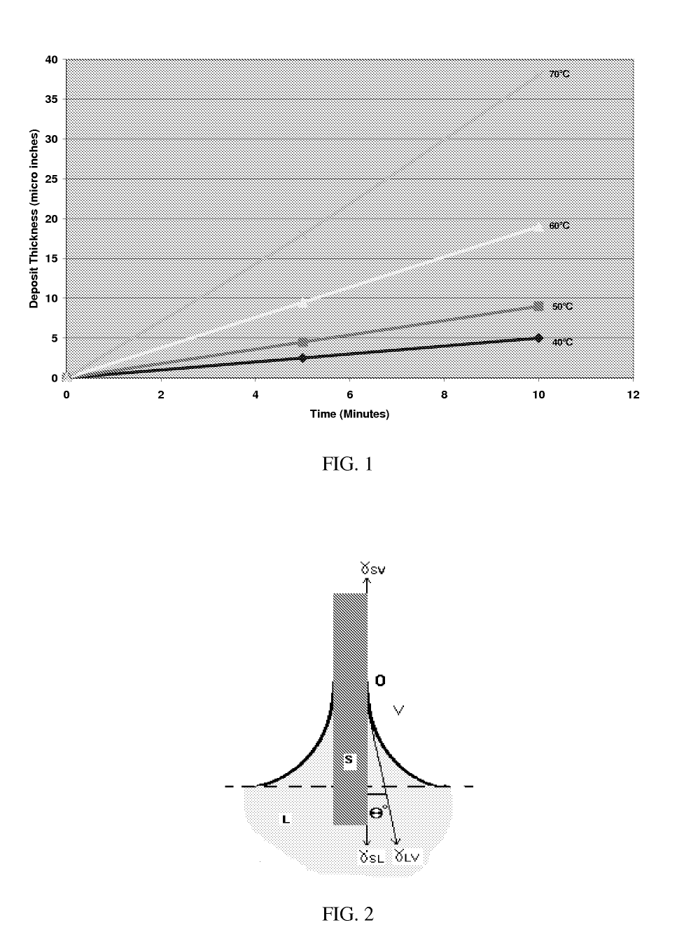

FIG. 1 is a graph representing a palladium deposit thickness as a function of time and temperature according to an embodiment of the invention;

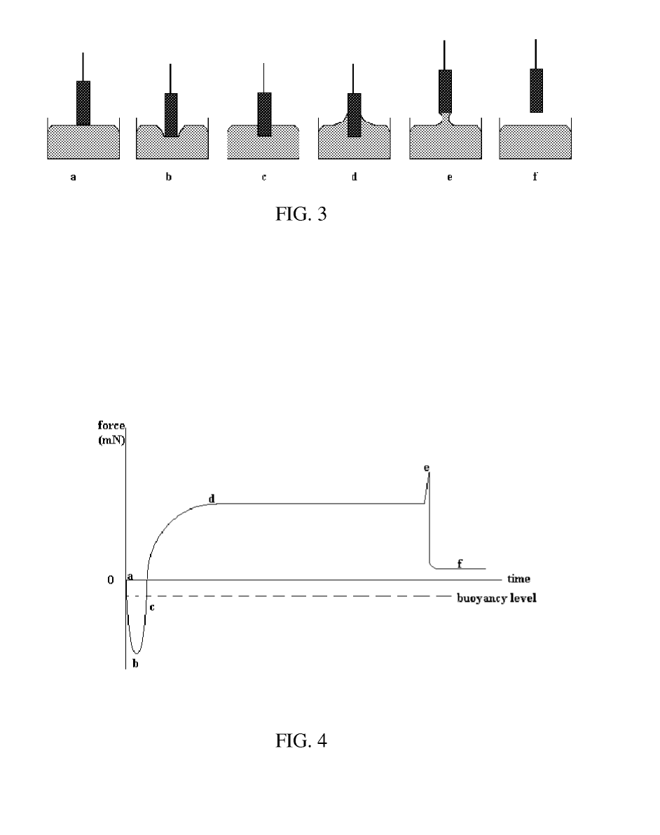

FIG. 2 is a schematic representation of a wetting balance analysis focusing on the surface tensions between the solid, liquid, and vapor phases of materials during soldering;

FIG. 3 is a schematic representation of the steps performed during wetting balance testing;

FIG. 4 is a representative plot of force versus time during the wetting balance testing performed as shown in FIG. 3;

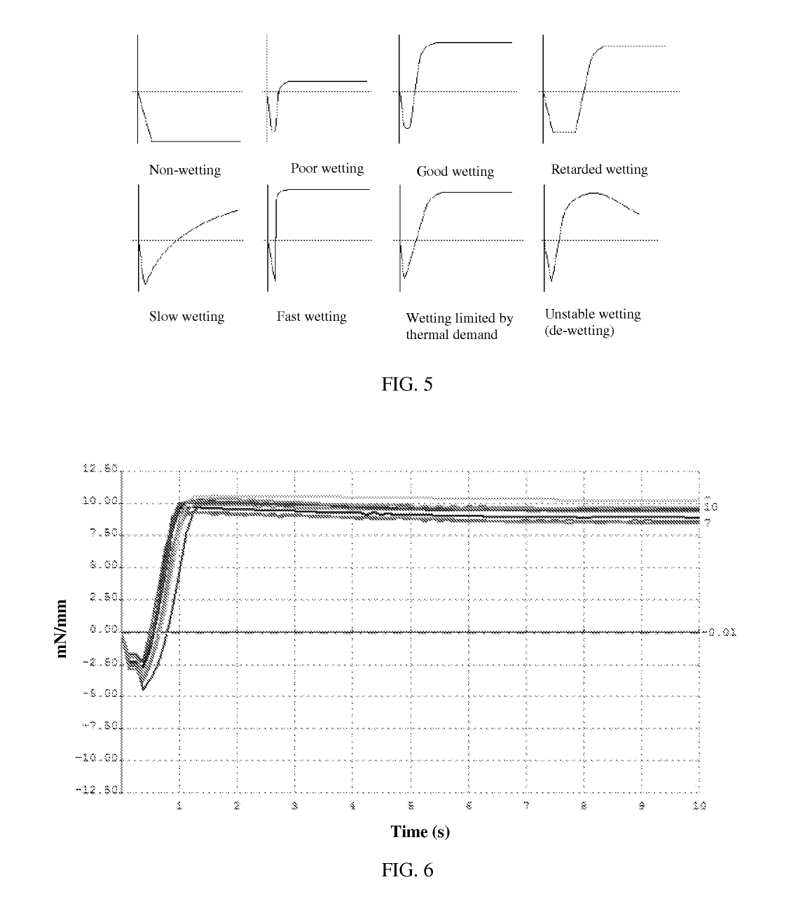

FIG. 5 is a series of interpretations of representative plots resulting from wetting balance tests;

FIG. 6 is a plot showing the results of wetting balance tests for as plated palladium on a copper substrate according to an embodiment of the invention;

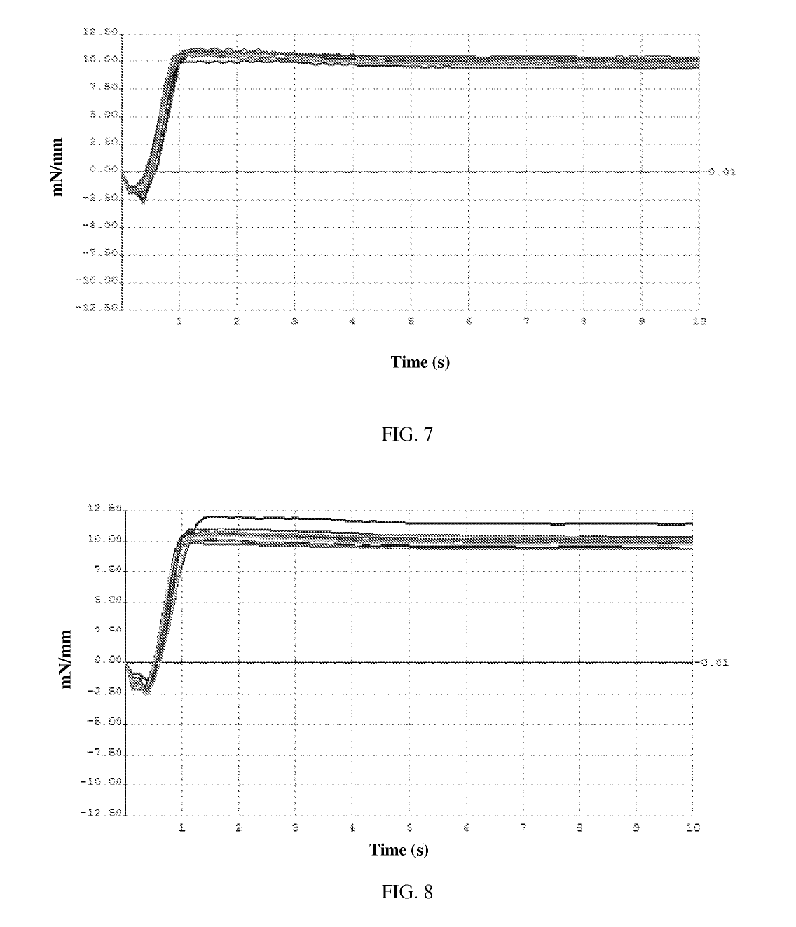

FIG. 7 is a plot showing the results of wetting balance tests for accelerated aging of plated palladium on a copper substrate after 8 hours at 72° C. and 85% relative humidity;

FIG. 8 is a plot showing the results of wetting balance tests for accelerated aging of plated palladium on a copper substrate after 24 hours at 72° C. and 85% relative humidity;

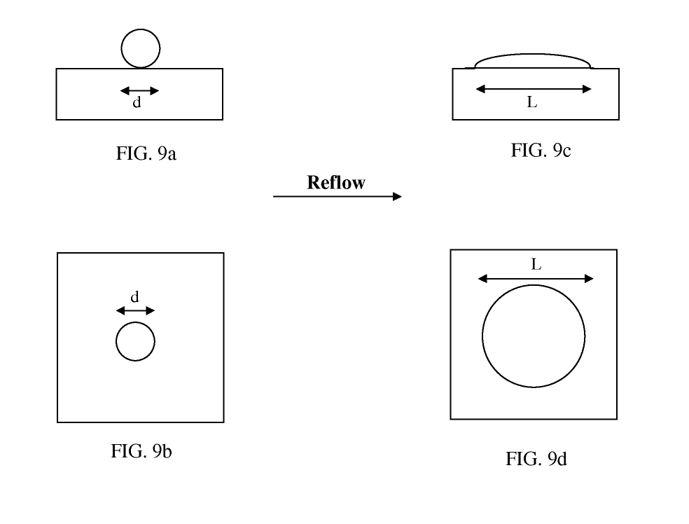

FIG. 9 is an explanatory view illustrating the process for measuring solder ball spread according to an embodiment of the invention;

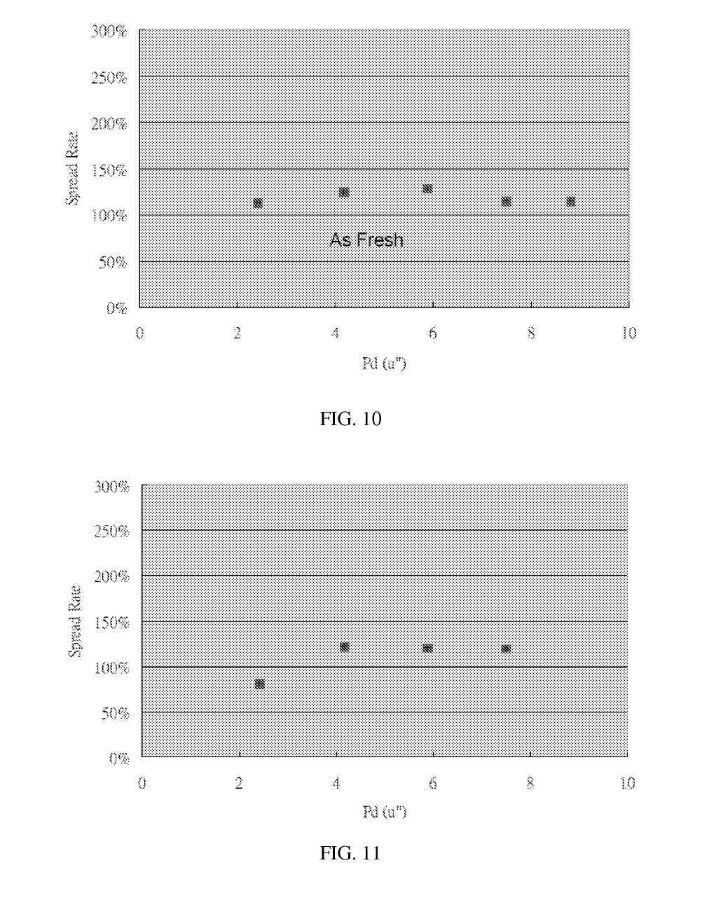

FIG. 10 is a graph of solder ball spread plotted as a function of % spread rate versus the fresh deposited electroless palladium in microinches; and

FIG. 11 is a graph of solder ball spread as plotted as a function of % spread rate versus a three-pass reflow of deposited electroless palladium in microinches.

### DETAILED DESCRIPTION OF THE INVENTION

An electroless palladium plating solution may be utilized in articles such as circuit board manufacturing, production of electronic components, such as hybrid circuits and substrates for integrated circuits, and the production of microelectrode arrays. Typically, the palladium is deposited onto the surface of the articles. The surface of the articles may include metals such as copper, silver, nickel and cobalt. Similarly, the surface of the articles may include alloys of metals such as copper, silver, nickel and cobalt. The palladium may also be deposited onto the surface of the articles for corrosion and solder protection.

In one embodiment of the invention, an electroless palladium plating solution includes at least one palladium salt, at least one non-nitrogenated complexing agent, an alkaline adjusting agent and a reducing agent in a polar solvent, such as water. The use of the non-nitrogenated complexing agent may prevent spontaneous precipitation of the reduced palladium in the plating solution prior to use. In addition, the use of the reducing agent of the invention facilitates the formation of a substantially pure palladium deposit.

The at least one palladium salt of the electroless plating solution may include palladium sulfate, palladium chloride, palladium acetate and mixtures thereof. In one embodiment of the invention, the at least one palladium salt may have a concentration in the range from about 10.0 g/L to about 70.0 g/L. In another embodiment of the invention, the at least one palladium salt may have a concentration in the range from about 30.0 g/L to about 50.0 g/L.

The at least one non-nitrogenated complexing agent may include sodium citrate, ammonium citrate, sodium malate, sodium phenol sulfonate, sodium tartrate, potassium sodium tartrate and mixtures thereof. In one embodiment of the invention, the at least one non-nitrogenated complexing agent may have a concentration in the range from about 1.0 g/L to about 30.0 g/L. In another embodiment of the invention, the at least one non-nitrogenated complexing agent may have a concentration in the range from about 5.0 g/L to about 20.0 g/L.

To establish and maintain an alkaline pH, an alkaline adjusting agent may be used. The alkaline adjusting agent may include ammonia and ammonium hydroxide. In one embodiment of the invention, the alkaline adjusting agent adjusts the pH of the electroless plating solution to a pH of at least 8.0. In another embodiment of the invention, the alkaline adjusting agent adjusts the pH of the electroless plating solution to a pH of at least 9.0.

The reducing agent may include formic acid as well as the salts of formic acid, i.e. metal formates, such as lithium formate, sodium formate, potassium formate, magnesium formate, calcium formate and aluminum formate. It may also be desirable to use ammonium formate as the reducing agent in one embodiment of the invention. In one embodiment of the invention, the reducing agent may have a concentration in the range from about 10.0 g/L to about 200.0 g/L. In another embodiment of the invention, the at least one palladium salt may have a concentration in the range from about 50.0 g/L to about 150.0 g/L.

In a method of forming a layer of palladium on a surface of a metal, an article having a metal surface is provided and contacted with a working bath that includes a palladium salt at a pH of greater than 8.0. Precipitation of the palladium in the bath may be substantially prevented by providing at least one non-nitrogenated complexing agent. Suitable complexing agents include, but are limited to, sodium citrate, ammonium citrate, sodium malate, sodium phenol sulfonate, sodium tartrate, and potassium sodium tartrate. Prior to contacting the metal surface of the article with the bath, the palladium is reduced by providing a reducing agent into the bath. Once the palladium is reduced, the metal surface of the article is contacted with the bath such that a layer of palladium is formed on at least a portion of the surface.

In one embodiment of the invention, the metal surface of the article is micro-etched and activated prior to being contacted with the working bath. For this purpose, the micro-etching is typically carried out in an oxidizing, acidic bath. In one embodiment, the micro-etching bath may include a solution of sulfuric acid, sulfuric peroxide and water. After the micro-etching is complete, the metal surface of the article is activated by exposure to an activating bath. In one embodiment, the activating bath may include a solution of phosphoric acid, sulfuric acid, hydrochloric acid, acetic acid and mixtures thereof and a palladium salt, including palladium chloride, palladium sulfate, palladium nitrate, palladium acetate and mixtures thereof. The activating bath may also include other components such as palladium deposit density modifiers including sodium nitrophenol sulfonate, o-nitrobenzoic acid, sodium phenol sulfonate, sodium benzene sulfonate and mixtures thereof; palladium deposit thickness modifiers including sodium nitrate, ammonium nitrate, potassium nitrate and mixtures thereof; and palladium deposit uniformity modifiers including ethoxylated secondary linear alcohols, such as Tergitol® 15-S-9, and high molecular weight glycol ethers, such as Carbowax® 8000. A thin layer of palladium, typically angstroms in thickness, is plated onto the metal surface of the article when exposed to the activating bath via an immersion, galvanic process.

In one embodiment, the metal surface of the article may be rinsed after being exposed to each of the micro-etching and the activating baths and then contacted with the working bath followed by subsequent rinsing and drying. In another embodiment, the metal surface of the article may be exposed to the working bath without exposure to the micro-etching and the activating baths, followed by subsequent rinsing and drying.

In general, the pH of the working bath is typically greater than 4.0. Test results have shown that at pH values below 4.0, the working bath has shown a propensity to spontaneously decompose. In particular, there is substantially little chance for recovery of the working bath as the palladium becomes unstable, typically resulting in a dark layer of palladium deposit, and may even precipitate out of solution at this low pH.

In one embodiment of the invention, the pH of the working bath is at least 8.0. In yet another embodiment of the invention, the pH of the working bath is at least 9.0. Prior art palladium working baths having pH-values greater than 7.0 have typically resulted in a palladium deposit that yields a less glossy finish on the metal surface of the article and the alkali environment has had a tendency to attack the organic films on the coated article. In contrast, the working bath of the present invention having a pH of at least 8.0 yields a layer of palladium deposit that is whitish metallic in color having acceptable uniformity and cosmetics.

In an embodiment of the invention, the method of forming a layer of palladium on a surface of a metal of an article includes depositing a layer of palladium onto the metal surface at a rate of about 0.025 μm/minute to about 0.075 μm/minute (about 1 microinch (μ″)/minute to about 3 microinches(μ″)/minute). In another embodiment of the invention, the layer of palladium deposited onto the metal surface is performed at a temperature ranging from about 40° C. to about 70° C. In yet another embodiment of the invention, the layer of palladium deposited onto the metal surface has a thickness in the range from about 0.1 μm to about 1.0 μm (about 4 μinch to about 40 μinches). A representative graph showing the layer of palladium thickness versus time and temperature is seen in FIG. 1.

Deposition may be carried out in conventional immersion units, in which the metal surface of the article to be treated is immersed substantially in the vertical direction in the working bath. However, it is also contemplated that the article may be moved through a treatment unit in the horizontal direction and at least a portion of the substrate comes into contact with the bath solution, for example, in a metallization unit for the selective metallization of contact areas on article.

The following Examples illustrate the components, as well as amounts, of the electroless palladium plating solution, but these examples are not considered to be limiting the scope of this invention.

### Example 1

### Electroless Palladium Process Cycle

| Step | Time (minutes) | Temperature (° C.) |
|---|---|---|
| Acid Cleaning | 3.0 | 40 |
| Rinse | 1.0 | Ambient |
| Micro-Etch | 2.0 | 40 |
| Rinse | 1.0 | Ambient |
| Activator | 1.0 | 40 |
| Rinse | 1.0 | Ambient |
| Electroless Palladium | 10.0 | 60 |
| Rinse | 1.0 | Ambient |
| Dry | 1.0 | Ambient |

### Example 2

An acid cleaning bath of the following composition was used for cleaning the metal surface of the article:

### Acid Cleaning Bath Composition

| Component | Amount |
|---|---|
| De-ionized Water | about 88.9% by volume |
| Glycolic Acid | about 5.0% by volume |
| Sulfuric Acid | about 1.0% by volume |
| Phosphoric Acid | about 5.0% by volume |
| Wetting Agent | about 0.05% by volume |
| Chelator | about 0.05% by volume |

In preparing the metal surface of an article, for example a copper coupon, printed circuit board or an electronic component, for palladium deposition, the article may be subjected to an acid cleaning bath to remove contaminants from the metal surface. The acid cleaning bath may be mechanically or ultrasonically agitated in order to facilitate the cleaning process.

### Example 3

A micro-etch bath of the following composition was used for etching the metal surface of the article:

### Micro-Etch Bath Composition

| Component | Amount |
|---|---|
| De-ionized Water | about 50% by volume |
| Sulfuric Peroxide | about 25% by volume |
| Sulfuric Acid | about 25% by volume |

The use of sulfuric peroxide in the acid cleaner bath was shown to improve the appearance of the metal surface of the article being plating.

### Example 4

### Activator Bath

An activator bath of the following composition was used for activating the metal surface of the article:

| Component | Range (g/L) | | Amount (g/L) | |
|---|---|---|---|---|
| Water | To 1 | L | To 1 | L |
| Phosphoric Acid | 5.0-250.0 | | 145.0 | |
| Sodium Phenol Sulfonate | 0.0-2.0 | | 0.15 | |
| Ammonium Nitrate | 0.0-1.0 | | 0.15 | |
| Tergitol ® 15-S-9 | 0.0-1.0 | | 0.04 | |
| Carbowax ® 8000 | 0.0-0.01 | | 0.01 | |
| Palladium Metal | 0.05-1.0 | | 0.10 | |
| (as Palladium Sulfate) | | | | |

### Example 5

### Electroless Palladium Bath

An electroless palladium bath of the following composition was used for plating the metal surface of the article:

| Component | Amount (g/L) | |
|---|---|---|
| Water | To 1 | L |
| Ammonium Citrate | 15.0 | g/L |
| Ammonium Hydroxide (58%) | 24 | mL |
| Sodium Phenol Sulfonate | 0.25 | g/L |
| Palladium Sulfate Solution (40 g/L) | 20 | mL |
| pH | 9.1 | |

One method in evaluating the quality of a metal deposit is to conduct solderability testing. In particular, solderability testing pertains to the process of evaluating the solderability of terminations (i.e., component leads, lugs, terminals, wires, etc.). Industry standards for performing solderability testing include:

### 1) Mil-Std-883 Method 2003—“Solderability”;

### 2) IPC JSTD-002—“Solderability Tests for Component Leads, Terminations, Lugs, Terminals and Wires”;

### 3) IPC JSTD-003—“Solderability Tests for Printed Boards”; and

### 4) JESD22-B102; and 5) Part 21 of the IEC 60749.

The solderability of a surface is defined by its solder wetting characteristics. Solder wetting pertains to the formation of a relatively uniform, smooth, and unbroken film of solder that exhibits excellent adherence on the soldered surface. Non-wetting, on the other hand, is the condition wherein the solder coating has contacted the surface but did not adhere completely to it, causing the surface or a part thereof to be exposed. Dewetting is the condition wherein the solder recedes after coating a surface, creating irregular mounds of solder, but leaving behind no exposed areas.

The two most common solderability testing methods include the Dip and Look Method and Wetting Balance Analysis. In both of these tests, the samples undergo an accelerated ‘aging’ process before being tested for solderability, to take into consideration the natural aging effects of storage prior to board-mounting.

The Dip and Look Method, which is widely used in process QA and reliability monitoring, is a qualitative test process, i.e., judgment on whether a sample passes or fails the test is based on the physical and visual attributes that it exhibits.

Wetting balance analysis, on the other hand, is a quantitative test, i.e., it measures the wetting forces imposed by the molten solder on the test surface as it is dipped into and held in the solder bath as a function of time and plotted. The plot starts with the wetting force being negative (non-wet condition), which rises until it crosses the zero axis of wetting force, indicating that wetting has occurred. The time it takes for wetting to occur is one parameter used to assess solderability. There are, however, no established industry-standard pass/fail criteria for wetting balance analysis, which is why it is used primarily as an engineering tool and not as a production monitor. Wetting force depends on the density and surface tension of the solder.

The scientific principles used in determining Wetting Balance are physical laws that date from the nineteenth century when two physicists, Thomas Young and Pierre-Simon LaPlace, evidenced a surface tension phenomenon which occurs when liquid, solid, and vapor phases are brought into contact with each other.

The fundamental Wetting laws applied to the soldering phenomenon are related to surface tensions. For example, a soldering alloy pellet put onto the surface of a metal plate previously fluxed and heated to a temperature at least equal to the melting temperature of the alloy deposit becomes liquid and more especially spreads out as the solid is wettable. The flux is an integral component since it prevents the metal plate from oxidation under the effect of the heat and to reduce oxides which may be present in the metal plate.

As seen in FIG. 2, the point O represents the junction between the solid, liquid and flux surface. The liquid phase is represented by the molten alloy. The solid phase corresponds to the components. The vapor phase corresponds to the flux evaporation. These three phases brought into contact two by two, generate forces called surface tensions. The equations which govern these surface tensions include:

γSV+γSL+γLV=0,

γSV=γSL+γLV·cos θ (Young's relation)

F=γLV·cos θ·P−ρ·v (LaPlace law)

Where the various parameters are defined by:
F=capillary forces;
ρ=specific mass of molten alloy;
v=volume of the component part immersed in the molten alloy;
ρ·v=Archimedean thrust generated by the component part immersed in the molten alloy;
γSV=solid component/flux vapor surface tension;
γSL=solid component/molten alloy surface tension;
γLV=molten alloy/flux vapor surface tension; and
P=component wettable perimeter

The above equations provide evidence, both physically and mathematically, that the value of the angle θ is fully representative of the quality of wetting (i.e. solderability). In general, the measurement of the angle θ can provide the degree of wetting balance as follows:

### 0°<θ<30° VERY GOOD WETTING

### 30°<θ<40° GOOD WETTING

### 40°<θ<55° ACCEPTABLE WETTING

### 55°<θ<70° POOR WETTING

### θ>70° VERY POOR WETTING

These relations are true when the wire (or sample) is immersed perpendicular at the surface of the alloy, and the dimensions are constant. If the sample is coil wires, it is necessary to straighten a wire. The wire dipping in the alloy should be straight as straight as possible.

In conducting wetting balance testing, as schematically shown in FIG. 3, the following steps may be taken:

a. Sample reaches the surface of the solder bath;

b. Sample is at the end of immersion depth;

c. Forces are at equilibrium;

d. Maximum wetting force is measure;

e. Sample is lifted out of the solder bath; and

f. Sample is removed from the solder bath.

Some typical results that may be obtained through wetting balance testing are provided schematically in FIG. 5.

Wetting balance testing was conducted in order to test the effectiveness of palladium deposits that resulted after the plating process according to an embodiment of the invention. In particular, IPC JSTD-003 protocol was used in conducting the tests. Based upon this protocol, parts were tested with a SAC305 solder at a temperature of about 255° C. A standard test flux #2 was used in conjunction with the SAC305 solder. Dwell time in the solder was about ten seconds and the immersion depth was about 0.4 mm.

The results of the different wetting balance tests are provided in FIGS. 6-8. In particular, FIG. 6 provides the results of the wetting balance tests for as plated palladium on a copper substrate. When compared to the representative wetting balance results as seen in FIG. 5, the wetting balance test results for the as plated materials shows acceptable wetting. Next, FIG. 7 provides the results of the wetting balance tests for accelerated aging of plated palladium on a copper substrate after 8 hours at 72° C. and 85% relative humidity. When compared to the representative wetting balance results as seen in FIG. 5, the wetting balance test results for the as plated materials shows acceptable wetting. These results show that the aged, plated surface is robust. Finally, FIG. 8 provides the results of the wetting balance tests for accelerated aging of plated palladium on a copper substrate after 24 hours at 72° C. and 85% relative humidity. When compared to the representative wetting balance results as seen in FIG. 5, the wetting balance test results for the as plated materials shows acceptable wetting. These results show that the plated surface has a robust shelf life.

Solder ball spread was measured in accordance with the measuring method as shown in FIGS. 9a-9d. That is, solder ball 10, having a diameter d, is placed on a palladium-coated copper conductor 11 (FIGS. 9a and 9b), and reflowed at the peak temperature in the atmosphere (FIGS. 9c and 9d). The solder ball spread ratio was calculated using the formula (L-d)/d.

The solder balls used in the evaluation were manufactured by Senju Metal Industry Company containing tin, silver, and copper. Evaluation of solder ball spread was made using 600 μm/760 μm solder balls with a peak temperature of 250° C. The results of the solder ball spread are shown in FIGS. 10 and 11. As shown in FIG. 10, the solder ball spread is plotted as a function of % spread rate versus the fresh deposited electroless palladium in microinches. The resulting plot yields a fairly consistent spread rate over a range of deposited palladium. As shown in FIG. 11, the solder ball spread is plotted as a function of % spread rate versus a three-pass reflow of deposited electroless palladium in microinches. The resulting plot yields a consistent spread rate when the deposited palladium layer is greater than four microinches.

Based upon the foregoing disclosure, it should now be apparent that the electroless plating solution and method of use thereof as described herein will carry out the objects set forth hereinabove. It is, therefore, to be understood that any variations evident fall within the scope of the claimed invention and thus, the selection of specific component elements can be determined without departing from the spirit of the invention herein disclosed and described.

What is claimed is:

1. An electroless plating solution comprising:
a polar solvent;
at least one palladium salt;
at least one non-nitrogenated complexing agent;
an alkaline adjusting agent, wherein the adjusting agent adjusts the plating solution to a pH of at least 8.0; and
a reducing agent.

2. The plating solution of claim 1, wherein the at least one palladium salt is selected from the group consisting of palladium sulfate, palladium chloride, palladium acetate and mixtures thereof.

3. The plating solution of claim 1, wherein the non-nitrogenated complexing agent is selected from the group consisting of sodium citrate, ammonium citrate, sodium malate, sodium phenol sulfonate, sodium tartrate, potassium sodium tartrate and mixtures thereof.

4. The plating solution of claim 1, wherein the alkaline adjusting agent is ammonium hydroxide.

5. The plating solution of claim 1, wherein the reducing agent is a salt of formic acid.

6. The plating solution of claim 5, wherein the salt of formic acid is sodium formate.

7. The plating solution of claim 1, wherein the polar solvent is water.

8. The plating solution of claim 1, wherein the pH of the plating solution is at least 9.0.

9. A method of forming a layer of palladium on a surface of an article, the method comprising the steps of:
providing an article having a metal surface, wherein the article is selected from the group consisting of a circuit board, a microelectrode and an electronic component;
providing a working bath comprising a palladium salt at a pH of greater than 8.0;
providing at least one non-nitrogenated complexing agent selected from the group consisting of sodium citrate, ammonium citrate, sodium malate, sodium phenol sulfonate, sodium tartrate, and potassium sodium tartrate;
reducing the palladium from the bath by providing a reducing agent; and
contacting the metal surface to the bath such that a layer of palladium is formed on at least a portion of the metal surface.

10. The method of claim 9 further comprising the steps of:
micro-etching the metal surface in a bath of sulfuric peroxide; and
activating the metal surface by contacting the metal surface to an acidic bath comprising a palladium salt.

11. The method of claim 10, wherein the acidic bath for activating the metal surface further comprises an oxidizing agent, an ethoxylated alcohols and a polyol.

12. The method of claim 9, wherein the pH is at least 9.0.

13. The method of claim 9, wherein the reducing agent is a salt of formic acid.

14. The method of 13, wherein the salt of formic acid is sodium formate.

15. The method of claim 9, wherein the layer of palladium is deposited onto the metal surface at a rate of about 0.025 μm/minute to about 0.075 μm/minute (about 1 μinch/minute to about 3 μinches/minute).

16. The method of claim 15, wherein the layer of palladium deposited onto the metal surface at a temperature ranging from about 40° C. to about 70° C.

17. The method of claim 9, wherein the layer of palladium deposited onto the metal surface has a thickness in the range from about 0.1 μm to about 1.0 μm (about 4 μinch to about 40 μinches).

18. The method of claim 9, wherein the metal surface comprises at least one of copper, silver, nickel and cobalt.

19. The method of claim 9, wherein the metal surface comprises an alloy of elements selected from the group consisting of copper, silver, nickel and cobalt.

20. An electroless plating solution comprising:
water;
palladium sulfate;
ammonium citrate;
ammonium hydroxide, wherein the ammonium hydroxide adjusts the plating solution to a pH of at least 8.0;
sodium phenol sulfonate; and
sodium formate.
